(19) United States
(12) Patent Application Publication
(10) Pub. No.: US 2026/0236765 A1
(43) Pub. Date: Aug. 13, 2026

(54) SEQUENTIAL RECOMMENDATION BASED ON CROSS-DOMAIN BEHAVIOR DATA

(71) Applicant: Microsoft Technology Licensing, LLC, Redmond, WA (US)

(72) Inventors: Ning WU, Haidian (CN); Ming GONG, Haidian (CN); Linjun SHOU, Haidian (CN); Daxin JIANG, Haidian (CN)

(21) Appl. No.: 19/150,493

(22) PCT Filed: Mar. 11, 2024
(86) PCT No.: PCT/US2024/019342

§ 371 Date: Jul. 23, 2025

(30) Foreign Application Priority Data
Mar. 30, 2023 (CN) 202310332238.3

(51) Int. Cl. G06N 3/08

(52) U.S. Cl. CPC G06N 3/08

(57) ABSTRACT

The present disclosure proposes a method, apparatus and computer-readable medium for sequential recommendation based on cross-domain behavior data. A target user representation of a target user may be generated based on a historical content item sequence of the target user. A cross-domain behavior sequence set may be extracted from a log of a network application. A cross-domain sequence representation set corresponding to the cross-domain behavior sequence set may be generated. A similar sequence representation set similar to the target user representation may be retrieved from the cross-domain sequence representation set. An interaction probability set of the target user interacting with a candidate content item set may be predicted based on the target user representation and the similar sequence representation set.

### BACKGROUND

With the development of network technology and the growth of network information, recommendation systems are playing an increasingly important role in many online services. Based on different recommended content, there are different recommendation systems, e.g., movie recommendation system, recipe recommendation system, book recommendation system, music recommendation system, etc. These recommendation systems usually capture interests of a user, and predict content that the user is interested in based on the interests of the user and recommend the content to the user.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose a method, apparatus and computer-readable medium for sequential recommendation based on cross-domain behavior data. A target user representation of a target user may be generated based on a historical content item sequence of the target user. A cross-domain behavior sequence set may be extracted from a log of a network application. A cross-domain sequence representation set corresponding to the cross-domain behavior sequence set may be generated. A similar sequence representation set similar to the target user representation may be retrieved from the cross-domain sequence representation set. An interaction probability set of the target user interacting with a candidate content item set may be predicted based on the target user representation and the similar sequence representation set.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for sequential recommendation based on cross-domain behavior data according to an embodiment of the present disclosure.

FIG. 2 illustrates an exemplary process for generating a comprehensive context representation according to an embodiment of the present disclosure.

FIG. 3 illustrates an exemplary process for training a sequential recommendation based on cross-domain behavior data according to an embodiment of the present disclosure.

FIG. 4 illustrates an exemplary process for generating a contrastive learning prediction loss according to an embodiment of the present disclosure.

FIG. 5 illustrates an exemplary process for generating a sub contrastive learning prediction loss according to an embodiment of the present disclosure.

FIG. 6 illustrates an exemplary process for obtaining a previous cross-domain sequence representation set according to an embodiment of the present disclosure.

FIG. 7 is a flowchart of an exemplary method for sequential recommendation based on cross-domain behavior data according to an embodiment of the present disclosure.

FIG. 8 illustrates an exemplary apparatus for sequential recommendation based on cross-domain behavior data according to an embodiment of the present disclosure.

FIG. 9 illustrates another exemplary apparatus for sequential recommendation based on cross-domain behavior data according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Sequential Recommendation is a widely used recommendation technique. Sequence recommendation aims to predict a subsequent interaction of a user according to a historical content item sequence of the user. The historical content item sequence may include content items with which the user has previously interacted. Herein, a content item may refer to an individual item with specific content. For example, a movie, a recipe, a book, a piece of music, etc., may be referred to as a content item. A target user representation of a target user may be generated based on a historical content item sequence of the target user, and a content item that the target user wants to interact with at a next moment may be predicted according to the target user representation. Herein, a target user refers to a user for which sequential recommendation is performed. The target user representation may be augmented with cross-domain behavior (CDB) data. Herein, cross-domain behavior data refers to user behavior records on applications across different domains. A domain may refer to the type of content that an application is targeted for. For example, a news application and a movie application may be considered as applications belonging to different domains. Cross-domain behavior data may contain rich information for inferring user interests. For example, many users are accustomed to using browsers to obtain desired information. Search query and browsing data collected by browsers may cover a large amount of user behavior data. This information may be used to infer user interests. At present, when performing sequential recommendation for a target user with cross-domain behavior data, usually only cross-domain behavior data of the target user is used. This approach requires a user to have a unified user identifier over applications across different domains. However, user identifiers of the same user on different applications are likely to be different. Therefore, the applicable scenarios of this approach are limited.

Embodiments of the present disclosure propose improved sequential recommendation based on cross-domain behavior data. A target user representation of a target user may be generated based on a historical content item sequence of the target user. A cross-domain behavior sequence set may be extracted from a log of a network application. Herein, a network application refers to an application capable of accessing various content or resources via a network connection, e.g., a browser, a video application, a news application, a recipe application, etc. The network application may be different from an application used to perform sequential recommendation based on cross-domain behavior data. The cross-domain behavior sequence set may be mapped to a cross-domain content item sequence set through entity linking. For example, each behavior may be mapped to a content item through entity linking, so as to obtain a cross-domain content item sequence set. A cross-domain sequence representation set may be generated based on the cross-domain content item sequence set. Subsequently, a similar sequence representation set similar to the target user representation may be retrieved from the cross-domain sequence representation set. The similar sequence representation set similar to the target user representation may be user representations of users having similar interests to the target user. The similar sequence representation set may be utilized to infer the interests of the target user, and enhance the target user representation. An interaction probability set of the target user interacting with a candidate content item set may be predicted based on the target user representation and the similar sequence representation set. The approach described above does not require a user to have a unified user identifier in applications across different domains, but utilizes similar sequence representations similar to the target user representation, and thus can enhance the target user representation through more fully utilizing the cross-domain behavior data. Accordingly, the approach described above can be widely applied to various sequential recommendation scenarios.

A similar sequence representation set similar to a target user representation may be retrieved from a cross-domain sequence representation set based on a relevance score between each cross-domain sequence representation and the target user representation. This process can filter out a sequence representation that is irrelevant to the target user representation at a sequence level. Further, each retrieved similar sequence representation includes a set of content item representations corresponding to the retrieved similar sequence representation. The set of content item representations may contain a content item representation that is irrelevant to the target user representation. In order to reduce the impact of the content item representation that is irrelevant to the target user representation on interaction probability prediction, the embodiments of the present disclosure design an attention selector at a content item level. For each content item representation in a set of content item representations corresponding to each similar sequence representation in the similar sequence representation set, the attention selector may calculate an attention weight corresponding to the content item representation based on the target user representation and the content item representation, to obtain a set of attention weights. A content item representation that is irrelevant to the target user representation may be calculated as having a lower attention weight. This set of attention weights may be used to generate a comprehensive context representation. The comprehensive context representation may then be used to predict an interaction probability set of the target user interacting with a candidate content item set. The process described above reduces the impact of the representation that is irrelevant to the target user representation on the interaction probability prediction at the sequence level and the content item level, which helps to predict a more accurate interaction probability.

The sequential recommendation based on cross-domain behavior data described above may be performed through a machine learning-based model. Herein, a model used to perform sequential recommendation based on cross-domain behavior data may be referred to as a sequential recommendation model based on cross-domain behavior data. For the purpose of simplification, the sequential recommendation model based on cross-domain behavior data is sometimes shorten to a sequential recommendation model hereafter. A sequential recommendation model may be trained through multiple stages. For example, an encoder in the sequential recommendation model for generating a target user representation may be trained with a sequence augmentation strategy and a momentum contrastive learning mechanism. Subsequently, a parameter of a momentum encoder in the sequential recommendation model for generating a cross-domain sequence representation set may be updated in a momentum manner. Next, a cross-domain sequence representation set corresponding to the cross-domain behavior sequence set may be generated through a momentum encoder, to construct a full retrieval index. Then, the entire sequential recommendation model may be trained in an end-to-end way. During the training process, the robustness of the encoder may be improved with the sequence augmentation strategy. In addition, the momentum contrastive learning mechanism may help the encoder to learn to distinguish the target user representation as a positive sample from a large amount of cross-domain sequence representation sets being a negative sample set, thereby improving the encoding ability of the encoder.

Various embodiments of the present disclosure will hereinafter be described in connection with the appended drawings.

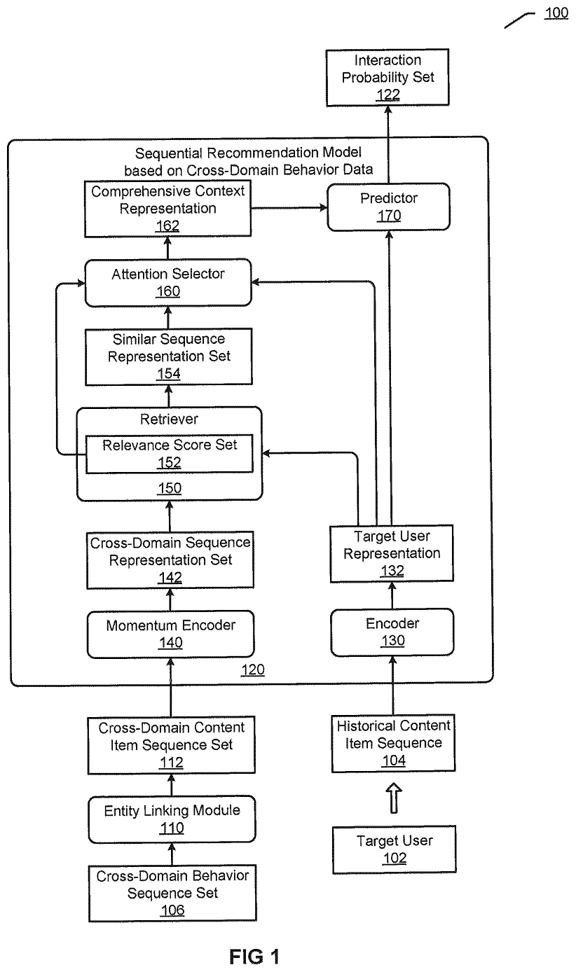

FIG. 1 illustrates an exemplary process 100 for sequential recommendation based on cross-domain behavior data according to an embodiment of the present disclosure. In the process 100, an interaction probability of a target user 102 interacting with each candidate content item in a candidate content item set may be predicted through a sequential recommendation model based on cross-domain behavior data 120, so as to obtain an interaction probability set 122. The interaction probability set 122 may be further used to predict a content item to be recommended to the target user 102 at the next time.

The target user 102 may be denoted as u. First, a historical content item sequence 104 of the target user 102 u may be obtained. The historical content item sequence 104 may be denoted as sᵤ=(v₁, . . . , vₜ, . . . , vₜ_{ᵤ}), where vₜ is a content item that the target user 102 interacted with at the time t, and lᵤ is the length of the historical content item sequence 104 sᵤ, i.e., the number of content items it includes. Herein, an interaction may broadly include various behaviors performed by a user on a content item, e.g., clicking, watching, browsing, etc. A content item may include. e.g., movie, video, book, music, news, recipe, product information, etc.

A target user representation 132 hᵤ of the target user 102 u may be generated based on the historical content item sequence 104 sᵤ through an encoder 130 in the sequential recommendation model based on cross-domain behavior data 120. The encoder 130 may be, e.g., an encoder part in a transformer. A representation of the last content item vₗ_{ᵤ} in the historical content item sequence 104 sᵤ generated through the encoder 130 may be used as the target user representation 132 hᵤ. The process described above may be as shown by the following formula:

$${h}_{u} = Transformer ( {s}_{u} ) \qquad ( 1 )$$

A cross-domain behavior sequence set 106 may be extracted from a log of a network application. The network application may include, e.g., a browser, a video application, a news application, a recipe application, etc. The network application may be different from an application used to perform sequential recommendation based on cross-domain behavior data. The process of extracting the cross-domain behavior sequence set 106 is described below by taking the network application being a browser as an example. A large amount of webpage browsing records may be obtained from a browser log. These webpage browsing records are usually kept anonymously, but webpage browsing records of different users are separated from each other. A web page browsing record of each user may be obtained. The web page browsing record of the user may be divided into multiple segments at a predetermined time interval. Each segment may be referred to as a cross-domain behavior sequence, which may include web pages browsed by the user within a time period. The cross-domain behavior sequences of all users may be combined into the cross-domain behavior sequence set 106. For other types of network applications, a cross-domain behavior sequence set may be extracted through a similar process.

A cross-domain sequence representation set corresponding to the cross-domain behavior sequence set 106 may be generated. In an implementation, the cross-domain behavior sequence set 106 may be mapped to a cross-domain content item sequence set 112 through an entity linking module 110. The entity linking module 110 may perform an entity linking operation on each behavior in the cross-domain behavior sequence set 106, to map the behavior into a content item, thereby obtaining the cross-domain content item sequence set 112. The cross-domain content item sequence set 112 may be denoted as C. Subsequently, a cross-domain sequence representation set 142 may be generated based on the cross-domain content item sequence set 112 through a momentum encoder 140. The momentum encoder 140 may be an encoder with the same structure as the encoder 130 but with different parameters.

The process described above will be described below by using a cross-domain content item sequence of any user d in the cross-domain content item sequence set 112 C. A cross-domain content item sequence of a user d may be denoted as

$${s}_{d}^{c} = ( {v}_{1}^{c} , … , {v}_{t}^{c} , … , {v}_{{l}_{d}}^{c} ) ,$$

where

$${v}_{t}^{c}$$

is a content item that the user d interacts with at the time t, and l_{d} is the length of the cross-domain content item sequence

$${s}_{d}^{c} .$$

A cross-domain sequence representation

$${r}_{d}^{c}$$

of the cross-domain content item sequence

$${s}_{d}^{c}$$

may be generated through the momentum encoder 140. A representation of the last content item

$${v}_{{l}_{c}}^{c}$$

in the cross-domain content item sequence

$${s}_{d}^{c}$$

generated through encoder 130 may be taken as a cross-domain sequence representation

$${r}_{d}^{c} .$$

The process described above may be as shown by the following formula:

$${r}_{d}^{c} = Transformer ( {s}_{d}^{c} ) \qquad ( 2 )$$

After obtaining the target user representation 132 hᵤ and the cross-domain sequence representation set 142, a similar sequence representation set 154 similar to the target user representation 132 hᵤ may be retrieved from the cross-domain sequence representation set 142 through a retriever 150. For example, for a cross-domain sequence representation

$${r}_{d}^{c}$$

in the cross-domain sequence representation set 142, a relevance score between the cross-domain sequence representation

$${r}_{d}^{c}$$

and the target user representation 132 hᵤ may be calculated. For example, this relevance score may be calculated through calculating an inner product between the cross-domain sequence representation

$${r}_{d}^{c}$$

and the target user representation 132 hᵤ, as shown by the following formula:

$$f ( {s}_{u} , {s}_{d}^{c} ) = {h}_{u}^{T} {r}_{d}^{c} \qquad ( 3 )$$

A relevance score between each cross-domain sequence representation and the target user representation 132 may be calculated, to obtain a relevance score set 152 corresponding to the cross-domain sequence representation set 142. The similar sequence representation set 154 may then be retrieved from the cross-domain sequence representation set 142 based on the relevance score set 152. The similar sequence representation set 154 may correspond to a similar sequence set. The similar sequence set may be denoted as

$$\{ {s}_{1}^{r} , {s}_{2}^{r} , … , {s}_{k}^{r} \} ,$$

where k is the number of sequences included in the similar sequence set. The similar sequence representation set 154 may be denoted as

$$\{ {r}_{1}^{c} , {r}_{2}^{c} , … , {r}_{k}^{c} \} .$$

In an implementation, a Maximum Inner Product Search (MIPS) algorithm may be employed to retrieve the similar sequence representation set 154 from the cross-domain sequence representation set 142. Retrieving the similar sequence representation set 154 similar to the target user representation 132 from the cross-domain sequence representation set 142 can filter out a sequence representation that is irrelevant to the target user representation 132 at a sequence level.

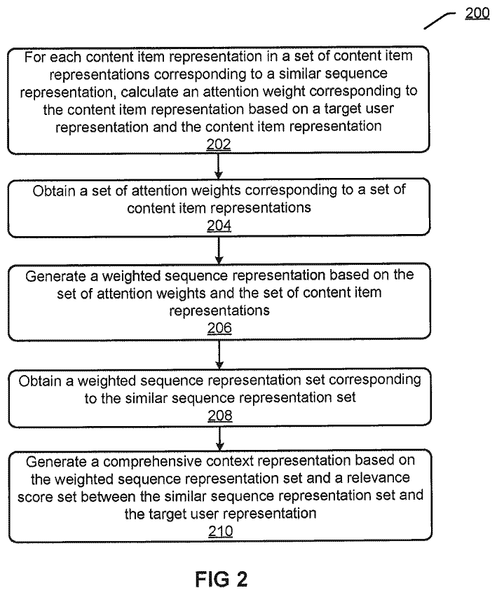

Subsequently, an interaction probability set 122 of the target user 102 interacting with a candidate content item set may be predicted based on the target user representation 132 and the similar sequence representation set 154. A candidate content item set may include movie, video, book, music, news, recipe, product information, etc. Each similar sequence representation in the similar sequence representation set 154 may include a set of content item representations corresponding to the similar sequence representation. The set of content item representations may contain a content item representation that is irrelevant to the target user representation 132. In order to reduce the impact of the content item representation that is irrelevant to the target user representation 132 on interaction probability prediction, the embodiments of the present disclosure design an attention selector 160 at a content item level. A comprehensive context representation 162 may be generated based on the target user representation 132, the similar sequence representation set 154, and the relevance score set between the similar sequence representation set 154 and the target user representation 132 through the attention selector 150. FIG. 2 illustrates an exemplary process 200 for generating a comprehensive context representation according to an embodiment of the present disclosure.

Each similar sequence representation in the similar sequence representation set may correspond to a set of content items, and may include a set of content item representations corresponding to the set of content items. At 202, for each content item representation in a set of content item representations corresponding to a similar sequence representation, an attention weight corresponding to the content item representation may be calculated based on the target user representation and the content item representation. The j-th content item representation in the similar sequence representation

$${r}_{d}^{c}$$

may be denoted as

$${r}_{d , j}^{c} .$$

The process for calculating an attention weight

$${α}_{u}^{j}$$

of the content item representation

$${r}_{d , j}^{c}$$

described above may be shown as the following formula:

$${α}_{u}^{j} = \frac{exp ( ( {W}_{1} {h}_{u} + {W}_{2} {r}_{d , j}^{c} ) )}{{\sum }_{j}^{{l}_{d}} exp ( {W}_{1} {h}_{u} + {W}_{2} {r}_{d , j}^{c} )} \qquad ( 4 )$$

where W₁ and W₂ are learnable model parameters. Through formula (4), a content item representation that is irrelevant to the target user representation may be made to have a lower attention weight.

The step 202 may be performed for each content item representation in the similar sequence representation, thereby at 204, a set of attention weights corresponding to the set of content item representations may be obtained.

At 206, a weighted sequence representation O_{d} may be generated based on the set of attention weights and the set of content item representations, as shown by the following formula:

$${O}_{d} = {\sum }_{j ∈ \{ 1 , 2 , … , {l}_{d} \}} {α}_{u}^{j} {r}_{d , j}^{c} \qquad ( 5 )$$

The step 202 to the step 206 may be performed for each similar sequence representation in the similar sequence representation set, thereby at 208, a weighted sequence representation set corresponding to the similar sequence representation set may be obtained.

At 210, a comprehensive context representation O may be generated based on the weighted sequence representation set and the relevance score set between the similar sequence representation set and the target user representation hᵤ, as shown by the following formula:

$$O = {\sum }_{d ∈ \{ 1 , 2 , … , k \}} f ( {s}_{u} , {s}_{d}^{r} ) {O}_{d} \qquad ( 6 )$$

where

$$f ( {s}_{u} , {s}_{d}^{r} )$$

is the relevance score between the similar sequence representation

$${r}_{d}^{c}$$

and the target user representation hᵤ. This score may be taken from the relevance score set 152.

Referring back to FIG. 1, after the comprehensive context representation 162 is generated, the interaction probability set 122 of the target user 102 interacting with the candidate content item set may be predicted based on the target user representation 132 and the comprehensive context representation 162 through the predictor 170. In an implementation, a two-layer multilayer perceptron (MLP) may be employed to predict an interaction probability p(vₜ|sᵤ, C) of the target user 102 interacting with each candidate content item vₜ in the candidate content item set, as shown by the following formula:

$$p ( {v}_{t} \vert {s}_{u} , C ) = \frac{exp ( {w}_{t}^{T} MLP ( {h}_{u} ‖ O ) )}{{\sum }_{j = 1}^{N} exp ( {w}_{j}^{T} MLP ( {h}_{u} ‖ O ) )} \qquad ( 7 )$$

where N is the number of candidate content items included in the candidate content item set, and

$${w}_{t}^{T} and {w}_{j}^{T}$$

are learnable parameters for the content item vₜ and the content item vⱼ, respectively.

The process 100 of sequential recommendation based on cross-domain behavior data described above does not require a user to have a unified user identifier in applications across different domains, but utilizes similar sequence representations similar to the target user representation, and thus can enhance the target user representation through more fully utilizing the cross-domain behavior data. Accordingly, the process 100 can be widely applied to various sequential recommendation scenarios.

In the process 100, retrieving the similar sequence representation set 154 similar to the target user representation 132 from the cross-domain sequence representation set 142 can filter out a sequence representation that is irrelevant to the target user representation 132 at a sequence level. In addition, in order to reduce the impact of the content item representation that is irrelevant to the target user representation 132 on the interaction probability prediction, for each content item representation in the set of content item representations corresponding to each similar sequence representation in the similar sequence representation set 154, the attention selector 160 at the content item level may calculate an attention weight corresponding to the content item representation based on the target user representation 132 and the content item representation, to obtain the set of attention weights. A content item representation that is irrelevant to the target user representation may be calculated as having a lower attention weight. This set of attention weights may be used to generate the comprehensive context representation 162. The comprehensive context representation 162 may then be used to predict the interaction probability set 122 of the target user 102 interacting with the candidate content item set. The process 100 reduces the impact of the representation that is irrelevant to the target user representation on the interaction probability prediction at the sequence level and the content item level, which helps to predict a more accurate interaction probability.

It should be appreciated that the process for sequential recommendation based on cross-domain behavior data described above in conjunction with FIGS. 1 to 2 is merely exemplary. Depending on actual application requirements, the steps in the process for sequential recommendation based on cross-domain behavior data may be replaced or modified in any manner, and the process may include more or fewer steps. In addition, the specific order or hierarchy of the steps in the process 100 is merely exemplary, and the process for sequential recommendation based on cross-domain behavior data may be performed in an order different from the described one. Furthermore, the sequential recommendation model based on cross-domain behavior data 120 shown in FIG. 1 is merely an example of the sequential recommendation model. Depending on actual application requirements, the sequential recommendation model may have any other structure, and may include more or fewer modules.

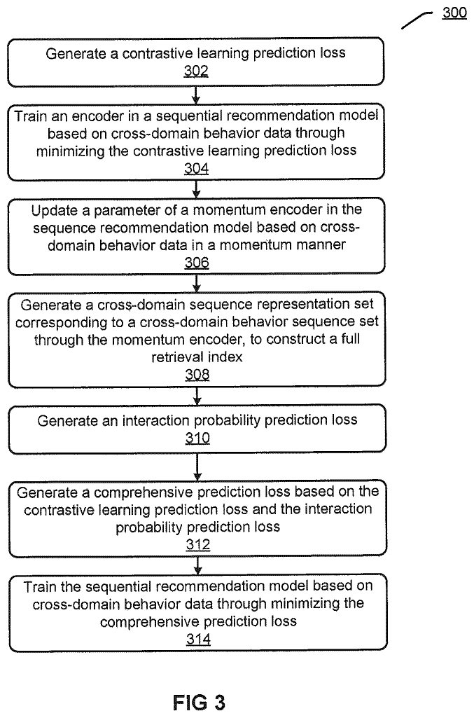

A sequential recommendation model based on cross-domain behavior data according to an embodiment of the present disclosure, such as the sequential recommendation model based on cross-domain behavior data 120 in FIG. 1, may be trained through multiple stages. FIG. 3 illustrates an exemplary process 300 for training a sequential recommendation based on cross-domain behavior data according to an embodiment of the present disclosure.

An encoder in a sequential recommendation model based on cross-domain behavior data may be trained. The encoder is, e.g., the encoder 130 in FIG. 1 for generating a target user representation. The encoder may be trained with a sequence augmentation strategy and a momentum contrastive learning mechanism.

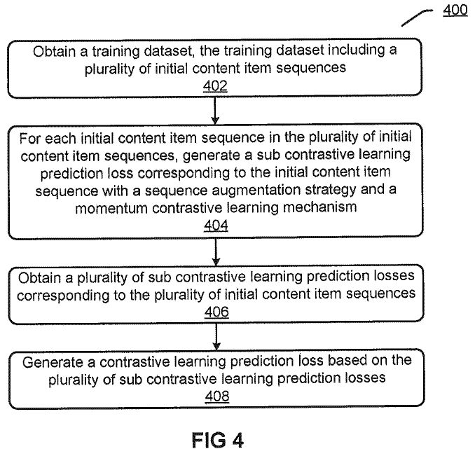

At 302, a contrastive learning prediction loss may be generated. FIG. 4 illustrates an exemplary process 400 for generating a contrastive learning prediction loss according to an embodiment of the present disclosure.

At 402, a training dataset [symbol] may be obtained. The training dataset [symbol] may include a plurality of initial content item sequences {sᵤ}.

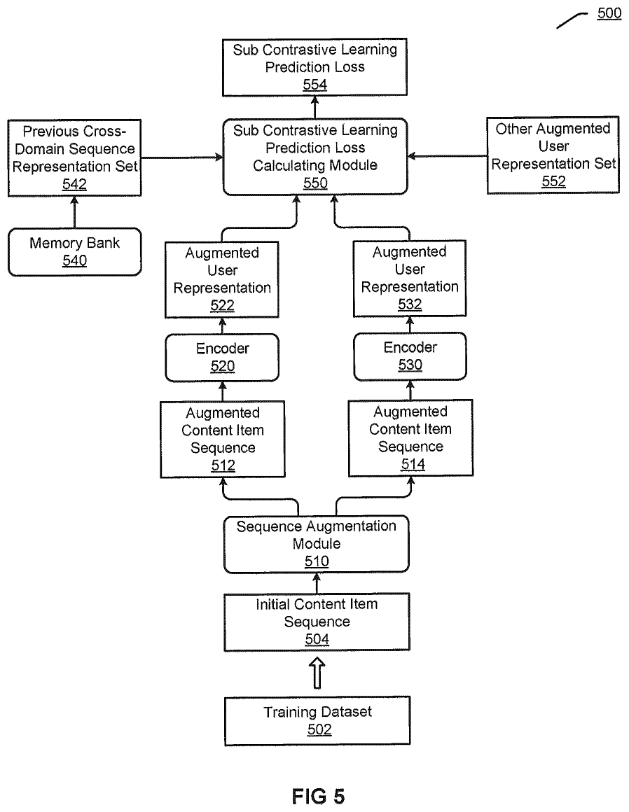

At 404, for each initial content item sequence in the plurality of initial content item sequences, a sub contrastive learning prediction loss corresponding to the initial content item sequence may be generated with a sequence augmentation strategy and a momentum contrastive learning mechanism. An exemplary process for generating a sub contrastive learning prediction loss will be described later in conjunction with FIG. 5. The sub contrastive learning prediction loss may be denoted as [symbol] .

The step 404 may be performed for each of the plurality of initial content item sequences, such that at 406, a plurality of sub contrastive learning prediction losses corresponding to the plurality of initial content item sequences may be obtained.

At 408, a contrastive learning prediction loss [symbol] may be generated based on the plurality of sub contrastive learning prediction losses, as shown by the following formula.

$${ℒ}_{CTS} = {\sum }_{{s}_{u} ∈ 𝒟} {ℒ}_{{s}_{u}} \qquad ( 8 )$$

Referring back to FIG. 3, after the contrastive learning prediction loss is generated [symbol] , at 304, an encoder in a sequential recommendation model based on cross-domain behavior data may be trained through minimizing the contrastive learning prediction loss.

After the encoder is trained, at 306, a parameter of a momentum encoder in the sequence recommendation model based on cross-domain behavior data may be updated in a momentum manner. The momentum encoder may be used to generate a cross-domain sequence representation set corresponding to a cross-domain behavior sequence set. The momentum encoder is, e.g., the momentum encoder 140 in FIG. 1. The process of updating the parameter of the momentum encoder may be as shown by the following formula:

$${θ}_{k} ← m {θ}_{k} + ( 1 - m ) {θ}_{q} \qquad ( 9 )$$

where θₖ is a parameter of the momentum encoder, m∈[0,1) is a coefficient of the momentum, and θ_{q} is a parameter of the encoder.

At 308, a cross-domain sequence representation set corresponding to the cross-domain behavior sequence set may be generated through the momentum encoder, to construct a full retrieval index.

Then, the entire sequential recommendation model based on cross-domain behavior data may be trained in an end-to-end manner.

At 310, an interaction probability prediction loss may be generated. The interaction probability prediction loss [symbol] may be calculated through using cross entropy as a loss function, as shown by the following formula:

$${ℒ}_{CF} = {\sum }_{{s}_{u} ∈ 𝒟} - log p ( {v}_{t} \vert {s}_{u} , C ) \qquad ( 10 )$$

where p(vₜ|sᵤ, C) is the interaction probability calculated by formula (7).

At 312, a comprehensive prediction loss [symbol] may be generated based on the contrastive learning prediction loss [symbol] and the interaction probability prediction loss [symbol] , as shown by the following formula:

$$ℒ = {ℒ}_{CTS} + {ℒ}_{CF} \qquad ( 11 )$$

At 314, the sequential recommendation model based on cross-domain behavior data may be trained through minimizing the comprehensive prediction loss [symbol] .

FIG. 5 illustrates an exemplary process 500 for generating a sub contrastive learning prediction loss according to an embodiment of the present disclosure. The process 500 may correspond to the step 404 in FIG. 4.

The process 500 may be performed on any initial content item sequence 504 sᵤ in a training dataset 502. Two sequence augmentation strategies may be performed on the initial content item sequence 504 sᵤ through a sequence augmentation module 510, to obtain two augmented content item sequences 512 and 514. The sequence augmentation strategies may include, e.g., a mask strategy, a reorder strategy, a crop strategy, etc.

The mask strategy intends to use a special token [mask] to randomly replace a content item in the initial content item sequence sᵤ with a probability γ∈(0,1). The mask strategy may be as shown by the following formula:

$${s}_{u}^{M} = {A}_{M} ( {s}_{u} ) = [ {v}_{1} , {v}_{[ mask ]} , … , {v}_{{l}_{u}} ] \qquad ( 12 )$$

where v_{[mask]} represents that the content item v₂ is selected and replaced with the special token [mask]. Each content item in the initial content item sequence sᵤ has an equal probability of being replaced with the special token [mask].

The reorder strategy intends to reorder content items in a consecutive subsequence of the initial content item sequence sᵤ. For example, a subsequence [vᵣ, . . . , vᵣ₊ᵢ_{ᵣ}] may be reordered as

$$[ {v}_{r + 1}^{′} , … , {v}_{r + {l}_{r}}^{′} ] .$$

The reorder strategy may be as shown by the following formula:

$${s}_{u}^{R} = {A}_{R} ( {s}_{u} ) = [ {v}_{1} , … , {v}_{r} , {v}_{r + 1}^{′} , … , {v}_{r + {l}_{r}}^{′} , … , {v}_{{l}_{u}} ] \qquad ( 13 )$$

where lᵣ=μ*lᵤ is the length of the reordered subsequence, and μ∈(0,1).

The crop strategy intends to randomly select a subsequence of length l_{c}=η*lᵤ, from the initial content item sequence sᵤ, where η∈(0,1). The crop strategy may be as shown by the following formula:

$${s}_{u}^{C} = {A}_{C} ( {s}_{u} ) = [ {v}_{c + 1} , … , {v}_{c + {l}_{c}} ] \qquad ( 14 )$$

Two sequence augmentation strategies may be randomly selected from the sequence augmentation strategies described above, to generate the two augmented content item sequences 512 and 514. During the training process, the robustness of an encoder may be improved through performing sequence augmentation strategies on the initial content item sequence.

An augmented user representation 522 of the augmented content item sequence 512 may be generated through an encoder 520. An augmented user representation 532 of the augmented content item sequence 514 may be generated through an encoder 530.

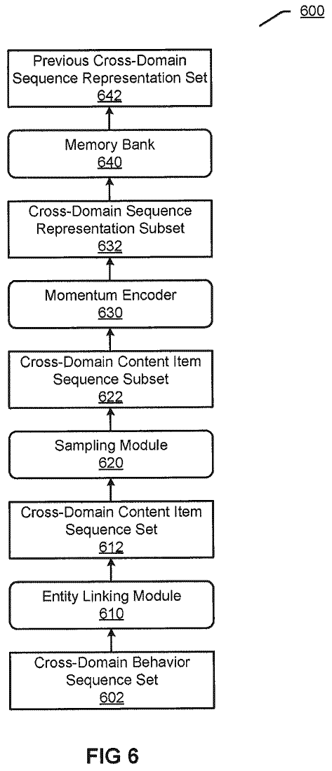

A previous cross-domain sequence representation set 542 may be extracted from a memory bank 540. The previous cross-domain sequence representation set 542 may be generated based on a cross-domain behavior sequence set. An exemplary process for obtaining a previous cross-domain sequence representation set will be described later in conjunction with FIG. 6. In addition, other augmented user representation set 552 corresponding to other initial content item sequences in the training dataset may also be obtained.

Subsequently, a sub contrastive learning prediction loss 554 may be generated based on the two augmented user representations 522 and 524, the previous cross-domain sequence representation set 542, and the other augmented user representation set 552 through a sub contrastive learning prediction loss calculating module 550. The sub contrastive learning prediction loss 554 may be denoted as [symbol] . The sub contrastive learning prediction loss [symbol] may be generated with a momentum contrastive learning mechanism. For example, the two augmented user representations 522 and 524 may be used as positive samples for each other, and the previous cross-domain sequence representation set 542 and the other augmented user representation set 552 may be used as negative sample sets, to generate the sub contrastive learning prediction loss [symbol] , as shown by the following formula:

$$( 15 )$$

$${ℒ}_{{s}_{u}} = {ℒ}_{{s}_{{u}_{i}} \cdot {s}_{{u}_{j}}} = - log \frac{exp ( \frac{{h}_{{u}_{i}} \cdot {h}_{{u}_{j}}}{τ} )}{{\sum }_{{j}^{′} = 1}^{2 M} \text{?} \vert {j}^{′} \neq i \vert exp ( \frac{{h}_{{u}_{i}} \cdot {h}_{{u}_{{j}^{′}}}}{τ} ) + {\sum }_{{j}^{′} = 1}^{K} exp ( \frac{{h}_{{u}_{i}} \cdot {r}_{{j}^{′}}^{c}}{τ} )}$$

where hᵤ_{ᵢ} and hᵤ_{ⱼ} are the two augmented user representations 522 and 524, respectively,

$${h}_{{u}_{{j}^{′}}}$$

is another augmented user representation in the other augmented user representation set 552,

$${r}_{{j}^{′}}^{c}$$

is a previous cross-domain sequence representation in the previous cross-domain sequence representation set 542, M is the number of initial content item sequences included in the training dataset 502, K is the number of previous cross-domain sequence representations included in the previous cross-domain sequence representation set 542, and τ is a temperature hyperparameter. The momentum contrastive learning mechanism may help the encoder to learn to distinguish the target user representation as a positive sample from a large amount of cross-domain sequence representation sets being a negative sample set, thereby improving the encoding ability of the encoder.

FIG. 6 illustrates an exemplary process 600 for obtaining a previous cross-domain sequence representation set according to an embodiment of the present disclosure. A previous cross-domain sequence representation set for generating a sub contrastive learning prediction loss, e.g., the previous cross-domain sequence representation set 542 in FIG. 5, may be obtained through the process 600.

A cross-domain behavior sequence set 602 may be mapped to a cross-domain content item sequence set 612 through an entity linking module 610. The entity linking module 610 may correspond to the entity linking module 110 in FIG. 1.

Subsequently, a cross-domain content item sequence subset 622 may be sampled from the cross-domain content item sequence set 612 through a sampling module 620. The cross-domain content item sequence subset 622 may be provided to a momentum encoder 630, to generate a cross-domain sequence representation subset 632 corresponding to the cross-domain content item sequence subset 622. The cross-domain sequence representation subset 632 may be added to a memory bank 640, and the earliest added cross-domain sequence representation in the memory bank 640 may be deleted. The cross-domain sequence representations currently located in the memory bank 640 may be combined into a previous cross-domain sequence representation set 642. The previous cross-domain sequence representation set 642 may be extracted when training an encoder for generating a target user representation of a target user, and may be used as a negative sample set when calculating a prediction loss.

It should be appreciated that the process for training the sequential recommendation model based on cross-domain behavior data described above in conjunction with FIG. 3 to FIG. 6 is merely exemplary. Depending on actual application requirements, the steps in the process for training the sequential recommendation model may be replaced or modified in any manner, and the process may include more or fewer steps. In addition, the specific orders or hierarchies of the steps in the process 300 to the process 600 are merely exemplary, and the process for training the sequential recommendation model may be performed in an order different from the described one.

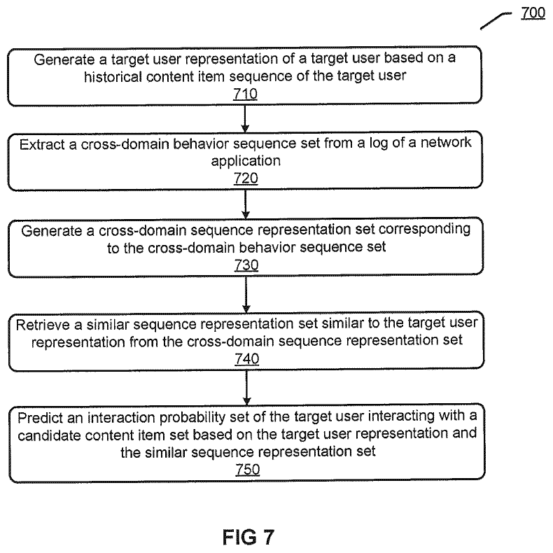

FIG. 7 is a flowchart of an exemplary method 700 for sequential recommendation based on cross-domain behavior data according to an embodiment of the present disclosure.

At 710, a target user representation of a target user may be generated based on a historical content item sequence of the target user.

At 720, a cross-domain behavior sequence set may be extracted from a log of a network application.

At 730, a cross-domain sequence representation set corresponding to the cross-domain behavior sequence set may be generated.

At 740, a similar sequence representation set similar to the target user representation may be retrieved from the cross-domain sequence representation set.

At 750, an interaction probability set of the target user interacting with a candidate content item set may be predicted based on the target user representation and the similar sequence representation set.

In an implementation, the generating a cross-domain sequence representation set corresponding to the cross-domain behavior sequence set may comprise: mapping the cross-domain behavior sequence set to a cross-domain content item sequence set through entity linking; and generating the cross-domain sequence representation set based on the cross-domain content item sequence set.

In an implementation, the retrieving a similar sequence representation set similar to the target user representation may comprise: for each cross-domain sequence representation in the cross-domain sequence representation set, calculating a relevance score between the cross-domain sequence representation and the target user representation, to obtain a relevance score set corresponding to the cross-domain sequence representation set; and retrieving the similar sequence representation set from the cross-domain sequence representation set based on the relevance score set.

In an implementation, the predicting an interaction probability set of the target user interacting with a candidate content item set may comprise: generating a comprehensive context representation based on the target user representation, the similar sequence representation set, and a relevance score set between the similar sequence representation set and the target user representation; and predicting the interaction probability set based on the target user representation and the comprehensive context representation.

The generating a comprehensive context representation may comprise: for each similar sequence representation in the similar sequence representation set, generating a weighted sequence representation based on the target user representation and the similar sequence representation, to obtain a weighted sequence representation set corresponding to the similar sequence representation set; and generating the comprehensive context representation based on the weighted sequence representation set and the relevance score set.

The generating a weighted sequence representation may comprise: for each content item representation in a set of content item representations corresponding to the similar sequence representation, calculating an attention weight corresponding to the content item representation based on the target user representation and the content item representation, to obtain a set of attention weights corresponding to the set of content item representations; and generating the weighted sequence representation based on the set of attention weights and the set of content item representations.

In an implementation, the target user representation may be generated through an encoder, and the encoder may be trained with a sequence augmentation strategy and a momentum contrastive learning mechanism.

The training of the encoder may comprise: obtaining a training dataset, the training dataset including a plurality of initial content item sequences;
for each initial content item sequence in the plurality of initial content item sequences, generating a sub contrastive learning prediction loss corresponding to the initial content item sequence with a sequence augmentation strategy and a momentum contrastive learning mechanism, to obtain a plurality of sub contrastive learning prediction losses corresponding to the plurality of initial content item sequences; generating a contrastive learning prediction loss based on the plurality of sub contrastive learning prediction losses; and training the encoder through minimizing the contrastive learning prediction loss.

The generating a sub contrastive learning prediction loss corresponding to the initial content item sequence may comprise: performing two sequence augmentation strategies on the initial content item sequence, to obtain two augmented content item sequences: generating two augmented user representations corresponding to the two augmented content item sequences; extracting a previous cross-domain sequence representation set from a memory bank, the previous cross-domain sequence representation set being generated based on the cross-domain behavior sequence set; obtaining other augmented user representation sets corresponding to other initial content item sequences in the training dataset; and generating the sub contrastive learning prediction loss based on the two augmented user representations, the previous cross-domain sequence representation set, and the other augmented user representation set.

In an implementation, the candidate content item set may include at least one of movie, video, book, music, news, recipe, and product information.

It should be appreciated that the method 700 may further comprise any step/process for sequential recommendation based on cross-domain behavior data according to the embodiments of the present disclosure as described above.

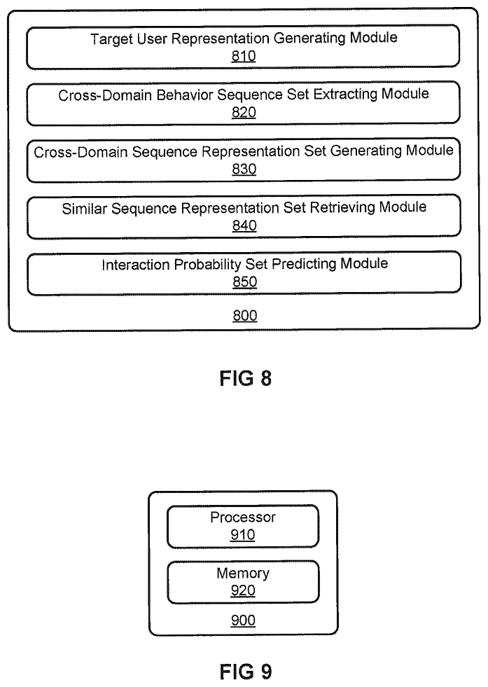

FIG. 8 illustrates an exemplary apparatus 800 for sequential recommendation based on cross-domain behavior data according to an embodiment of the present disclosure.

The apparatus 800 may comprise: a target user representation generating module 810, for generating a target user representation of a target user based on a historical content item sequence of the target user; a cross-domain behavior sequence set extracting module 820, for extracting a cross-domain behavior sequence set from a log of a network application; a cross-domain sequence representation set generating module 830, for generating a cross-domain sequence representation set corresponding to the cross-domain behavior sequence set; a similar sequence representation set retrieving module 840, for retrieving a similar sequence representation set similar to the target user representation from the cross-domain sequence representation set; and an interaction probability set predicting module 850, for predicting an interaction probability set of the target user interacting with a candidate content item set based on the target user representation and the similar sequence representation set. Moreover, the apparatus 800 may further comprise any other modules configured for sequential recommendation based on cross-domain behavior data according to the embodiments of the present disclosure as described above.

FIG. 9 illustrates another exemplary apparatus 900 for sequential recommendation based on cross-domain behavior data according to an embodiment of the present disclosure.

The apparatus 900 may comprise a processor 910; and a memory 920 storing computer-executable instructions. The computer-executable instructions, when executed, may cause the processor 910 to: generate a target user representation of a target user based on a historical content item sequence of the target user, extract a cross-domain behavior sequence set from a log of a network application, generate a cross-domain sequence representation set corresponding to the cross-domain behavior sequence set, retrieve a similar sequence representation set similar to the target user representation from the cross-domain sequence representation set, and predict an interaction probability set of the target user interacting with a candidate content item set based on the target user representation and the similar sequence representation set.

In an implementation, the generating a cross-domain sequence representation set corresponding to the cross-domain behavior sequence set may comprise: mapping the cross-domain behavior sequence set to a cross-domain content item sequence set through entity linking; and generating the cross-domain sequence representation set based on the cross-domain content item sequence set.

In an implementation, the retrieving a similar sequence representation set similar to the target user representation may comprise: for each cross-domain sequence representation in the cross-domain sequence representation set, calculating a relevance score between the cross-domain sequence representation and the target user representation, to obtain a relevance score set corresponding to the cross-domain sequence representation set; and retrieving the similar sequence representation set from the cross-domain sequence representation set based on the relevance score set.

In an implementation, the predicting an interaction probability set of the target user interacting with a candidate content item set may comprise: generating a comprehensive context representation based on the target user representation, the similar sequence representation set, and a relevance score set between the similar sequence representation set and the target user representation; and predicting the interaction probability set based on the target user representation and the comprehensive context representation.

The generating a comprehensive context representation may comprise: for each similar sequence representation in the similar sequence representation set, generating a weighted sequence representation based on the target user representation and the similar sequence representation, to obtain a weighted sequence representation set corresponding to the similar sequence representation set; and generating the comprehensive context representation based on the weighted sequence representation set and the relevance score set.

The generating a weighted sequence representation may comprise: for each content item representation in a set of content item representations corresponding to the similar sequence representation, calculating an attention weight corresponding to the content item representation based on the target user representation and the content item representation, to obtain a set of attention weights corresponding to the set of content item representations; and generating the weighted sequence representation based on the set of attention weights and the set of content item representations.

In an implementation, the target user representation may be generated through an encoder. The encoder may be trained with a sequence augmentation strategy and a momentum contrastive learning mechanism.

A training of the encoder may comprise: obtaining a training dataset, the training dataset including a plurality of initial content item sequences; for each initial content item sequence in the plurality of initial content item sequences, generating a sub contrastive learning prediction loss corresponding to the initial content item sequence with a sequence augmentation strategy and a momentum contrastive learning mechanism, to obtain a plurality of sub contrastive learning prediction losses corresponding to the plurality of initial content item sequences; generating a contrastive learning prediction loss based on the plurality of sub contrastive learning prediction losses; and training the encoder through minimizing the contrastive learning prediction loss.

The generating a sub contrastive learning prediction loss corresponding to the initial content item sequence may comprise: performing two sequence augmentation strategies on the initial content item sequence, to obtain two augmented content item sequences; generating two augmented user representations corresponding to the two augmented content item sequences; extracting a previous cross-domain sequence representation set from a memory bank, the previous cross-domain sequence representation set being generated based on the cross-domain behavior sequence set; obtaining other augmented user representation sets corresponding to other initial content item sequences in the training dataset; and generating the sub contrastive learning prediction loss based on the two augmented user representations, the previous cross-domain sequence representation set, and the other augmented user representation set.

It should be appreciated that the processor 910 may further perform any other steps/processes of the method for sequential recommendation based on cross-domain behavior data according to the embodiments of the present disclosure as described above.

The embodiments of the present disclosure propose a computer program product for sequential recommendation based on cross-domain behavior data, comprising a computer program that is executed by a processor for: generating a target user representation of a target user based on a historical content item sequence of the target user; extracting a cross-domain behavior sequence set from a log of a network application: generating a cross-domain sequence representation set corresponding to the cross-domain behavior sequence set: retrieving a similar sequence representation set similar to the target user representation from the cross-domain sequence representation set; and predicting an interaction probability set of the target user interacting with a candidate content item set based on the target user representation and the similar sequence representation set. In addition, the computer program may further be performed for implementing any other steps/processes of the method for sequential recommendation based on cross-domain behavior data according to the embodiments of the present disclosure as described above.

The embodiments of the present disclosure may be embodied in a computer-readable medium. The computer-readable medium may comprise instructions that, when executed, cause a processor to: generate a target user representation of a target user based on a historical content item sequence of the target user; extract a cross-domain behavior sequence set from a log of a network application; generate a cross-domain sequence representation set corresponding to the cross-domain behavior sequence set; retrieve a similar sequence representation set similar to the target user representation from the cross-domain sequence representation set; and predict an interaction probability set of the target user interacting with a candidate content item set based on the target user representation and the similar sequence representation set. In addition, the instructions, when executed, may further cause the processor to perform any other steps/processes of the method for sequential recommendation based on cross-domain behavior data according to the embodiments of the present disclosure as described above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for sequential recommendation based on cross-domain behavior data, comprising:
generating a target user representation of a target user based on a historical content item sequence of the target user;
extracting a cross-domain behavior sequence set from a log of a network application:
generating a cross-domain sequence representation set corresponding to the cross-domain behavior sequence set;
retrieving a similar sequence representation set similar to the target user representation from the cross-domain sequence representation set; and
predicting an interaction probability set of the target user interacting with a candidate content item set based on the target user representation and the similar sequence representation set.

2. The method of claim 1, wherein the generating a cross-domain sequence representation set corresponding to the cross-domain behavior sequence set comprises:
mapping the cross-domain behavior sequence set to a cross-domain content item sequence set through entity linking; and
generating the cross-domain sequence representation set based on the cross-domain content item sequence set.

3. The method of claim 1, wherein the retrieving a similar sequence representation set similar to the target user representation comprises:
for each cross-domain sequence representation in the cross-domain sequence representation set, calculating a relevance score between the cross-domain sequence representation and the target user representation, to obtain a relevance score set corresponding to the cross-domain sequence representation set; and
retrieving the similar sequence representation set from the cross-domain sequence representation set based on the relevance score set.

4. The method of claim 1, wherein the predicting an interaction probability set of the target user interacting with a candidate content item set comprises:
generating a comprehensive context representation based on the target user representation, the similar sequence representation set, and a relevance score set between the similar sequence representation set and the target user representation; and
predicting the interaction probability set based on the target user representation and the comprehensive context representation.

5. The method of claim 4, wherein the generating a comprehensive context representation comprises:
for each similar sequence representation in the similar sequence representation set, generating a weighted sequence representation based on the target user representation and the similar sequence representation, to obtain a weighted sequence representation set corresponding to the similar sequence representation set; and
generating the comprehensive context representation based on the weighted sequence representation set and the relevance score set.

6. The method of claim 5, wherein the generating a weighted sequence representation comprises:
for each content item representation in a set of content item representations corresponding to the similar sequence representation, calculating an attention weight corresponding to the content item representation based on the target user representation and the content item representation, to obtain a set of attention weights corresponding to the set of content item representations; and
generating the weighted sequence representation based on the set of attention weights and the set of content item representations.

7. The method of claim 1, wherein the target user representation is generated through an encoder, and the encoder is trained with a sequence augmentation strategy and a momentum contrastive learning mechanism.

8. The method of claim 7, wherein a training of the encoder comprises:
obtaining a training dataset, the training dataset including a plurality of initial content item sequences;
for each initial content item sequence in the plurality of initial content item sequences, generating a sub contrastive learning prediction loss corresponding to the initial content item sequence with a sequence augmentation strategy and a momentum contrastive learning mechanism, to obtain a plurality of sub contrastive learning prediction losses corresponding to the plurality of initial content item sequences;
generating a contrastive learning prediction loss based on the plurality of sub contrastive learning prediction losses; and
training the encoder through minimizing the contrastive learning prediction loss.

9. The method of claim 8, wherein the generating a sub contrastive learning prediction loss corresponding to the initial content item sequence comprises:
performing two sequence augmentation strategies on the initial content item sequence, to obtain two augmented content item sequences;
generating two augmented user representations corresponding to the two augmented content item sequences;
extracting a previous cross-domain sequence representation set from a memory bank, the previous cross-domain sequence representation set being generated based on the cross-domain behavior sequence set;
obtaining other augmented user representation sets corresponding to other initial content item sequences in the training dataset; and
generating the sub contrastive learning prediction loss based on the two augmented user representations, the previous cross-domain sequence representation set, and the other augmented user representation set.

10. The method of claim 1, wherein the candidate content item includes at least one of movie, video, book, music, news, recipe, and product information.

11. An apparatus for sequential recommendation based on cross-domain behavior data, comprising:
a processor; and
a memory storing computer-executable instructions that, when executed, cause the processor to:
generate a target user representation of a target user based on a historical content item sequence of the target user,
extract a cross-domain behavior sequence set from a log of a network application,
generate a cross-domain sequence representation set corresponding to the cross-domain behavior sequence set,
retrieve a similar sequence representation set similar to the target user representation from the cross-domain sequence representation set, and
predict an interaction probability set of the target user interacting with a candidate content item set based on the target user representation and the similar sequence representation set.

12. The apparatus of claim 11, wherein the predicting an interaction probability set of the target user interacting with a candidate content item set comprises:
generating a comprehensive context representation based on the target user representation, the similar sequence representation set, and a relevance score set between the similar sequence representation set and the target user representation; and
predicting the interaction probability set based on the target user representation and the comprehensive context representation.

13. The apparatus of claim 12, wherein the generating a comprehensive context representation comprises:
for each similar sequence representation in the similar sequence representation set, generating a weighted sequence representation based on the target user representation and the similar sequence representation, to obtain a weighted sequence representation set corresponding to the similar sequence representation set; and
generating the comprehensive context representation based on the weighted sequence representation set and the relevance score set.

14. The apparatus of claim 11, wherein the target user representation is generated through an encoder, and the encoder is trained with a sequence augmentation strategy and a momentum contrastive learning mechanism.

15. A computer-readable medium for sequential recommendation based on cross-domain behavior data, comprising instructions that, when executed, cause a processor to:
generate a target user representation of a target user based on a historical content item sequence of the target user;
extract a cross-domain behavior sequence set from a log of a network application;
generate a cross-domain sequence representation set corresponding to the cross-domain behavior sequence set;
retrieve a similar sequence representation set similar to the target user representation from the cross-domain sequence representation set; and
predict an interaction probability set of the target user interacting with a candidate content item set based on the target user representation and the similar sequence representation set.
